(19) United States
(12) Patent Application Publication
(10) Pub. No.: US 2024/0125388 A1
(43) Pub. Date: Apr. 18, 2024

(54) METHOD OF MAKING A GASKET FOR A DOUBLE BUSBAR AND A DOUBLE BUSBAR

(71) Applicant: Lisa Draexlmaier GmbH, Vilsbiburg (DE)

(72) Inventors: Josef ZAUNER, Pischelsdorf (AT); Fabian LETTNER, Burgkirchen (AT)

(73) Assignee: Lisa Draexlmaier GmbH, Vilsbiburg (DE)

(21) Appl. No.: 18/379,244

(22) Filed: Oct. 12, 2023

(30) Foreign Application Priority Data
Oct. 12, 2022 (DE) 102022126621.4

(51) Int. Cl. F16J 15/10; B60R 16/023; H02G 5/06; H02G 15/00

(52) U.S. Cl. CPC F16J 15/108; B60R 16/0238; H02G 5/06; H02G 15/003; B60L 50/60

(57) ABSTRACT

A method of manufacturing a gasket for a double busbar is disclosed. The double busbar may be composed of two separate electrically insulated flat conductors. The conductors may be arranged one above the other. The double busbar may be placed in a mold cavity for molding the gasket. The mold cavity may be closed around the double busbar and filled with a sealing material. The introduced sealing material flows around the flat conductors, adhering to the flat conductors, and solidifying in the mold cavity to form a gasket molded to the double busbar.

### CROSS REFERENCE TO RELATED APPLICATIONS

This application claims priority to German Patent Application DE102022126621.4, filed Oct. 12, 2022, the content of which is hereby incorporated by reference.

### BACKGROUND OF THE INVENTION

### Field of the Invention

The present invention relates to a method of making a gasket or a seal for a double busbar and to a double busbar having such a gasket or seal.

### Description of Related Art

The present invention is described below primarily in connection with busbars for electrically powered vehicles.

Electrical power for driving an electrically powered vehicle can be transmitted via busbars having a large conductor cross-section arranged between a traction battery of the vehicle and its drive system. To avoid losses, a high voltage level can be used, as this allows electrical power to be transmitted with correspondingly low electrical current. The voltage level can be much higher than in vehicle on-board power systems. Accordingly, the busbars may operate electrically separate or independent from the vehicle's electrical system.

A busbar is essentially a strip of metallic conductive material including a conductor cross-section over its width and thickness. Pairs of busbars may be next to one another. Busbars may also be arranged one above the other, such being typically referred to as a double busbar. Individouble busbars may be coated and/or enclosed in an insulating sheath that may be configured to protect the busbars from corrosion and other negative environmental influences. At a transition point into an enclosure, busbars of a double busbar may be separated and enter such enclosure through two separate bushings.

### BRIEF SUMMARY OF THE INVENTION

An object of the present invention is to provide an improved method for producing a gasket or seal (hereinafter referred to as gasket) for a double busbar as well as an improved double busbar of simpler design. An improvement in this respect may relate, for example, to the omission of a bushing at the transition from an unprotected region of the double busbar to a protected region.

In the approach presented herein, a common gasket is cast onto both busbars of a double busbar. The gasket is firmly connected to the busbars by the casting-on process.

The approach presented here allows the busbars of a double busbar to be guided into a housing through a common feedthrough. By connecting the gasket to the busbars, liquid creep along the busbars can be reliably prevented.

A first object of the present invention includes a method for manufacturing a gasket for a double busbar, the double busbar comprising two separate electrically insulated flat conductors arranged one above the other, wherein the double busbar is placed in a mold cavity for molding the gasket, wherein the mold cavity is closed around the double busbar and filled with a sealing material, the sealing material flowing around the flat conductors, adhering to the flat conductors and solidifying in the mold cavity to form the gasket molded onto the double current bar.

A second object of the present invention is directed to a double busbar comprising two separate electrically insulated flat conductors arranged one above the other, the flat conductors being connected by a gasket molded to the double busbar.

A double busbar conductor may comprise two substantially similar flat conductors. The flat conductors may be made of a metallic material, such as an aluminum material. The flat conductors may each be disposed in or coated with a sheath of electrically insulating plastic material. The sheath may be molded to the flat conductors. The two flat conductors may be bundled together, for example by wrapping them with adhesive tape, in order to form the double busbar. The flat conductors may be referred to as busbars.

A sealing material may be a plastic material. The sealing material may be provided and/or processed in a liquid or paste-like state. For example, the sealing material may be mixed from at least two components such that the mixture solidifies, in particular crosslink, after mixing. In a solidified or cross-linked state, the sealing material may be permanently elastic. Likewise, the sealing material may be plasticized by the action of pressure and/or heat and then solidified by cooling.

The liquid or paste-like sealing material may be introduced into a mold cavity. The liquid or paste-like sealing material then at least partially or preferably completely fills the mold cavity and thereby assumes a contour of the mold cavity at least in partial areas or as a whole. The liquid or paste-like sealing material solidifies, cross-links or otherwise subsequently solidifies in this contour.

The liquid or paste-like sealing material may bond with the flat conductors or the sheaths of the flat conductors. The sealing material may adhere to the flat conductors. For example, the sealing material can cling to a surface of the flat conductors or the sheaths. The sealing material may also chemically bond with the flat conductors or sheaths. Ultimately, a material-locking and/or form-fitting connection may be established between the sealing material and the flat conductors.

The flat conductors of the double busbar may be bent apart in the mold cavity to create a defined gap between the flat conductors. The sealing material may penetrate into the gap between the flat conductors and solidify in the gap. This allows the sealing material to flow around an entire circumference of the flat conductors.

The mold cavity may be formed by a housing disposed on the double busbar. The gasket material may further bond to the housing. The contour of the gasket may be formed by walls of the housing provided therefor. The mold cavity may be a chamber formed in or by the housing. The mold cavity may be a portion of the housing. The mold cavity may include an inlet opening and an outlet opening for the double busbar. The sealing material may be adhered to the housing. The sealing material may bond the double busbar to the housing.

Alternatively, the mold cavity may be temporarily formed by a mold for producing the gasket. The double busbar with the cast-on gasket may be removed from the mold cavity. A mold may be used multiple times to produce similar gaskets each time. The mold may be treated with a release agent to prevent adhesion of the gasket material to the mold. In particular, the mold cavity may have a smooth surface to prevent the seal material from caking. The double busbar with the molded-on seal may then be used, for example, on a housing feedthrough of a housing.

The flat conductors may be pretreated before insertion, at least in the area of the gasket. Pretreatment can change a surface of the flat conductors to improve adhesion of the sealing material. For example, the flat conductors can be roughened in the area of the gasket. The roughening can be done mechanically and/or chemically. During the pretreatment, a surface layer of the flat conductors can be removed. For example, the insulator of the flat conductors has a particularly smooth surface. The flat conductors may be plasma-treated in particular.

The flat conductors may be wrapped before insertion, at least in the area of the gasket. For example, the flat conductors may be wrapped with an adhesive tape. The adhesive tape may be, for example, a fabric tape. An adhesive of the adhesive tape may have good adhesion to a surface of the flat conductors. The sealing material may adhere well to a back surface of the adhesive tape. For example, the back surface may have a structure in and/or to which the sealing material may adhere. The adhesive tape may also be made of a material with which the sealing material forms a strong bond.

A gap at at least one entry point of the double busbar into the mold cavity may be sealed. The entry point may, for example have sealing lips. The sealing lips may be deformed, at least slightly, when the double busbar is inserted. The sealing lips may rest against the flat conductors and seal the gap. The sealing lips can be pressed against the flat conductors by the sealing material when the mold cavity is filled. This may strengthen the sealing effect of the sealing lips.

The gap may also be sealed using a sealing compound. A sealing compound may be introduced into the gap and bridge the gap. The sealing compound may be injected into the gap, for example.

The gap can be sealed using at least one loose or removable part that at least partially maps a contour of the gap. The removable part can be arranged in the gap before closing of the mold cavity, during closing or after closing. For example, the removable part may map a contour of the double busbar on a part of its contour and abut the double busbar. On another part of the contour, the removable part may map an outer contour of the gap and lie against an edge of the gap. The removable part may have sealing lips for sealing.

The molded part may be arranged in the gap between the flat conductors. The molded part may close and seal the gap between the flat conductors. The molded part may map part of the contour of the flat conductors on each of its two opposite flat sides.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

An advantageous embodiment of the present invention is set out below with reference to the accompanying figures, wherein:

FIG. 1 depicts an illustration of a double busbar in a mold for casting on a gasket according to an embodiment; and

FIG. 2 depicts an illustration of a double busbar with a gasket cast into a housing in accordance with an embodiment.

The figures are schematic representations and serve only to explain the invention. Identical or similarly acting elements are marked throughout with the same reference signs.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should not be understood as including only one of A, only one of B, only one of C, or any combination of A, B, and C

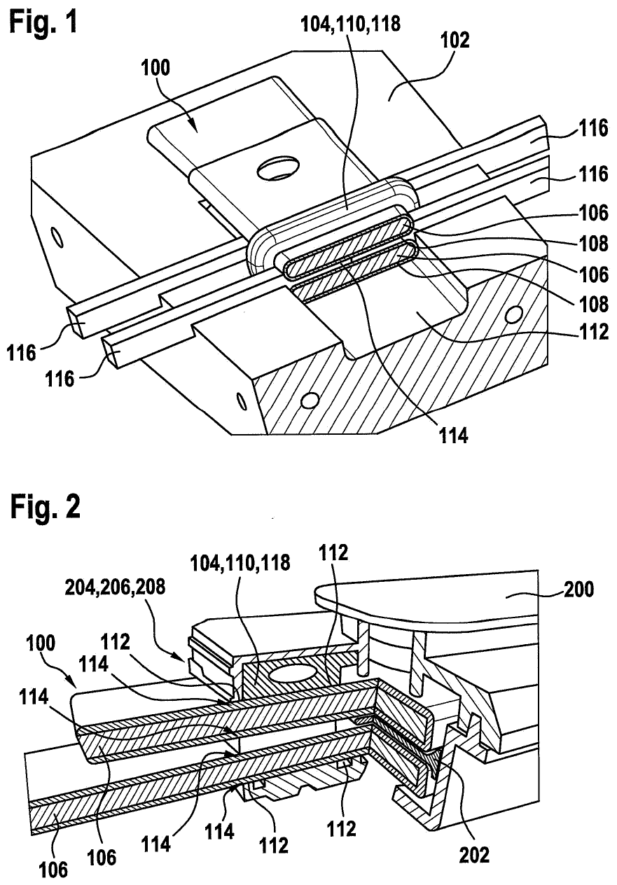

FIG. 1 depicts an illustration of a double busbar 100 in a mold 102 for casting on a gasket 104, according to an example embodiment of the present invention. The double current busbar 100 comprises two substantially parallel flat conductors 106 arranged with their flat sides above one another. The flat conductors 106 are strips of an electrically conductive metallic material. The metallic material is encased by an electrically insulating insulator 108. The insulator 108 is made of a plastic material. In particular, the plastic material may be a thermoplastic.

The flat conductors 106 provide large conductor cross sections for transmitting high electrical power, drive power and recuperation or recovered power. The insulator 108 is dimensioned for automotive high voltage with voltages in the range of 1000 volts.

The mold 102 has a cavity that forms a mold cavity 110 for the gasket 104 and receptacles 112 for the flat conductors 106 of the double busbar 100. The cavity is divided between two mold halves. One of the mold halves of the mold 102 is shown here. A parting plane of the tool halves is centered between the flat conductors 106. Thus, receptacles 112 for one of the flat conductors 106 and half of the mold cavity 110 are disposed in each half of the mold. The receptacles 112 are interrupted by the mold cavity 110. Thus, the receptacles 112 extend on two opposite sides of the mold cavity 110 in the mold 102.

The mold cavity 110 extends around both flat conductors 106 of the double busbar 100. The mold cavity 110 also extends over a portion of a gap 114 between the flat conductors 106. To seal the portion, the mold 102 includes removable parts 116. The removable parts 116 are mounted in guides of the mold 102 and are arranged to fill gap 114 located on either side of the mold cavity 110. Accordingly, the removable parts 116 may form contours on the flat conductors in certain effected areas. As such, the removable parts 116 bear against the flat conductors at least with a line contact and seal the gap 114 at an entry point and an exit point of the double busbar 100 with the mold cavity 110.

In one embodiment, the mold 102 has four removable parts 116, each pair of which delimits the mold cavity 110 on one side. The removable parts are laterally insertable into the gap 114.

To produce the seal 104, the flat conductors 106 are inserted into the receptacles 112, the mold halves are moved together, and the mold cavity is sealed by the removable parts 116. The mold cavity 110 is then filled with a liquid or at least paste-like sealing material 118. The sealing material 118 flows around the flat conductors 106 in the area of and within the mold cavity 110 adhering to a surface of the flat conductors 106. Then, the sealing material 118 solidifies in the mold cavity 110 thereby assuming the contour of the mold cavity 110.

After the seal material 118 has solidified to form the gasket 104, the mold halves are moved apart, the removable parts 116 are removed from the gap 114, and the double busbar 100 with the cast-on seal 104 removed from mold 102.

In one embodiment, the flat conductors 106 are pre-treated prior to insertion into the receptacles 112, at least in the area of the seal 104, in order to achieve improved adhesion of the seal material 118 to the double busbar 100. To this end, the insulator 108 may be plasma treated to modify a surface of insulator 108 in order to achieve the improved adhesion.

In one embodiment, the flat conductors are wrapped with an adhesive tape in the area of the seal 104. The adhesive tape has an adhesive suitable for a material of the insulator 108. The adhesive tape adheres firmly to the surface of the flat conductors and to itself. The sealant material 118, in turn, adheres to a back surface of the adhesive tape. The backing may comprise, for example, a fabric material. The fabric material may have a rough surface to which the sealing material 118 may readily adhere.

FIG. 2 depicts an illustration of a double busbar 100 with a seal 104 molded into a housing 200 according to an embodiment of the present invention. The double busbar 100 depicted in FIG. 2 is substantially the same as the double busbar depicted in FIG. 1. In contrast to FIG. 1 however, the mold cavity 110 is formed by the housing 200. The mold cavity 110 may be a chamber of housing 200. The mold cavity is separated from a remaining interior of the housing 200 by a rib of the housing 200.

As with the mold depicted in FIG. 1, the housing 200 has two halves that are opened to insert the flat conductors 106 into receptacles 112 of the housing 200. The receptacles 112 are thereby formed at least partially by walls of the mold cavity 110.

Again, to form the seal 104, the flat conductors 106 are inserted into the receptacles 112 and the housing 200 is closed to form the mold cavity 110 around the double busbar 100. The mold cavity 110 is then filled with sealing material 118. In doing so, the sealing material 118 bonds to the double busbar 100 and walls of the mold cavity 110. The sealing material 118 thus bonds the double busbar 100 and housing 200.

To achieve a sufficiently complete filling of the mold cavity, the mold cavity 110 has at least one sprue and at least one vent. The sprue and vent may be closed before and after potting by self-closing, slotted membranes.

In an embodiment of the present invention, an electrically insulating intermediate part 202 may be arranged between the flat conductors 106 before the housing 200 is closed. The intermediate part 202 forms a contour of and/or for the flat conductors 106 on their flat sides. The intermediate part 202 may be arranged in the interior of the housing 200 so as to seal the mold cavity 110 from the interior.

In an embodiment of the present invention, prior to filling the mold cavity 110 with sealing material, an entry point 204 of the double busbar 100 into the housing 200 or the mold cavity 110 is sealed by a sealing compound 206. The sealing compound 206 thereby closes gap 114 thus preventing sealing material 118 from escaping from the mold cavity 110.

In an embodiment of the present invention, the housing 200 includes sealing lips 208 at the entry point 204. The sealing lips 208 engage the double busbar 100 when the double busbar 100 is inserted into receptacles 112, thereby sealing gap 114. When the mold cavity 110 is filled with the sealing material 118, the sealing lips 208 are pressed against the double busbar 100 by a static pressure in the sealing material 118. The sealing effect of the sealing lips 208 is thus increased.

In the following, embodiments of the present invention are summarized and/or presented with a slightly different choice of words.

A sealing for high-voltage double busbar is presented. It is possible to seal around and on a busbar as well as to seal housings that are installed on the high-voltage double busbar.

For this purpose, either busbars are inserted into a foaming tool or a mold and then encapsulated, or housings or components are installed on the high-voltage busbar and subsequently encapsulated with casting compound/polyurethane foam.

The approach presented herein may be used to seal housings and separation points. Polyurethane foam, which is used for cable bushings (grommets) as a proven material for sealing requirements, may be used.

The approach presented herein may be automated, as the foaming process or potting may be integrated directly into a production sequence. With potting housings, no tool is required and no additional parts need to be inserted.

The approach presented herein produces adherent seals on double busbars. No prefabricated gaskets are required for sealing housings.

To ensure good adhesion to the busbars, the busbars may be pretreated with plasma. Alternatively, the busbars may be wrapped, wide or narrow, with adhesive tape. For the wide wrap, for example, a 19-millimeter wide fabric tape may be used. For narrow wrapping, a 9-millimeter wide fabric tape may be used.

For example, a mixture of a polyol component and an isocyanate component may be used as the sealing material. The gasket material may be elastic in cured form and have a tough skin. The sealing material may be a foam.

Since the devices and methods described in detail above are examples of embodiments, they can be modified to a wide extent by the skilled person in the usual manner without leaving the scope of the invention. In particular, the mechanical arrangements and the proportions of the individual elements with respect to each other are merely exemplary.

What is claimed is:

1. A method for manufacturing a gasket for a double busbar, the method comprising the steps of:
forming the double busbar from two separate electrically insulated flat conductors arranged one above another,
arranging the double busbar in a mold cavity configured to mold a gasket,
introducing sealing material into the mold cavity such that the sealing material flows around and adheres to the flat conductors thereby forming the gasket as the sealing material solidifies and molds to the double busbar, and
wherein the mold cavity defines a closed space around the double busbar.

2. The method according to claim 1, wherein the mold cavity comprises a housing configured to accommodate the double current bar such that the sealing material bonds with the housing after it is introduced into the cavity.

3. The method according to claim 1, further comprising the steps of forming the mold cavity by a mold configured to produce the gasket such that the double busbar with the gasket is removable from the mold cavity.

4. The method according to claim 1, further comprising the steps of pretreating the flat conductors at least in a region of the gasket prior to the step of arranging the double busbar in a mold cavity.

5. The method according to claim 1, further comprising the steps of wraping the flat conductors at least in a region of the gasket prior to the step of arranging the double busbar in a mold cavity.

6. The method according to claim 1, further comprising the steps of sealing a gap located at at least one entry point of the double busbar into the mold cavity.

7. The method of claim 6, further comprising the steps of sealing the gap by sealing lips.

8. The method according to claim 6, further comprising the step steps of sealing the gap with a sealant.

9. The method according to claim 6, further comprising the steps of sealing the gap using at least one removable part configured to at least partially map a contour of the gap.

10. The method according to claim 9, further comprising the steps of disposing the removable part between the flat conductors.

11. A double busbar comprising two separate electrically insulated flat conductors arranged one above another, wherein the flat conductors are connected by a gasket molded to the double busbar.
